(19) United States
(12) Patent Application Publication
(10) Pub. No.: US 2004/0012681 A1
(43) Pub. Date: Jan. 22, 2004

(54) Detachable telescope camera with shutter release linking means

(76) Inventor: Chia Jung Wu, Ta Lin Jen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/197,596

(22) Filed: Jul. 18, 2002

(51) Int. Cl. H04N 5/225

(52) U.S. Cl. 348/207.99

(57) ABSTRACT

A detachable telescope camera is constructed to include a telescope unit, a digital camera, detachable coupling means adapted for detachably securing the digital camera to the telescope unit at a bottom side for taking photos of the object viewed through the telescope unit, and a press member supported on a spring member at the central focusing drive of the telescope unit and adapted for triggering the shutter release of the digital camera.

### BACKGROUND OF THE INVENTION

1. Field of the Invention

The present invention relates to telescopes and digital cameras and, more specifically, to a telescope camera, which comprises a binoculars, a digital camer, a detachably fastened to the binoculars at a bottom side for use with the binoculars, and linking means mounted in the central focusing drive of the binoculars and adapted for driving the shutter release of the digital camera.

2. Description of the Prior Art

When viewing the image of the wild field or a sports game at a distance, a telescope, binoculars, or opera glasses may be used. Further, following fast development of digital technology, digital cameras have become more and more popularly used instead of conventional mechanical cameras. However, due to limited focusing distance, a digital camera cannot be used to view an object at a distance. Therefore, there is desirable to provide a telescope camera that enables the user to view the image of an object clearly at a distance and to simultaneously take the photos of the object in view. However, if a digital camera and a binoculars are combined together, the user cannot be conveniently operate the central focusing drive of the binoculars and the shutter release of the digital camera with one finger.

### SUMMARY OF THE INVENTION

The present invention has been accomplished under the circumstances in view. It is the main object of the present invention to provide a detachable telescope camera, which combines a binoculars with a digital camera so that the user can take photos with the digital camera when viewing the field at a distance with the binoculars. It is another object of the present invention to provide a detachable telescope camera, which enables the user to adjust the central focusing drive of the binoculars and the shutter release of the digital camera conveniently with the same finger. According to one aspect of the present invention, a detachable coupling structure is provided for detachably securing the digital camera to the binoculars at the bottom, so that the user can use the digital camera with the binoculars. If desired, the user can separate the digital camera from the binoculars for use separately. According to another aspect of the present invention, shutter release linking means is installed in the binoculars and adapted for triggering the shutter release of the digital camera. The central focusing drive of the digital camera comprises an annular groove around the periphery of the middle defining a center shaft. The shutter release linking means comprises a press member suspended in the annular groove of the central focusing drive around the center shaft of the central focusing drive and adapted for pressing by one finger to trigger the shutter release of the digital camera, and a spring member connected between the press member and the center shaft of the central focusing drive and supporting the press member in an off position where the shutter release of the digital camera is off.

### BRIEF DESCRIPTION OF THE DRAWINGS

FIG. 1 is an exploded view of a detachable telescope camera according to the present invention.

FIG. 2 is an elevational assembly view of the detachable telescope camera according to the present invention.

FIG. 3 is a sectional view of the detachable telescope camera according to the present invention showing the press member supported in the off position.

FIG. 4 is similar to FIG. 3 but showing the press member depressed, the shutter release triggered.

FIG. 5 is a sectional view of an alternate form of the detachable telescope camera according to the present invention.

### DETAILED DESCRIPTION OF THE PREFERRED EMBODIMENT

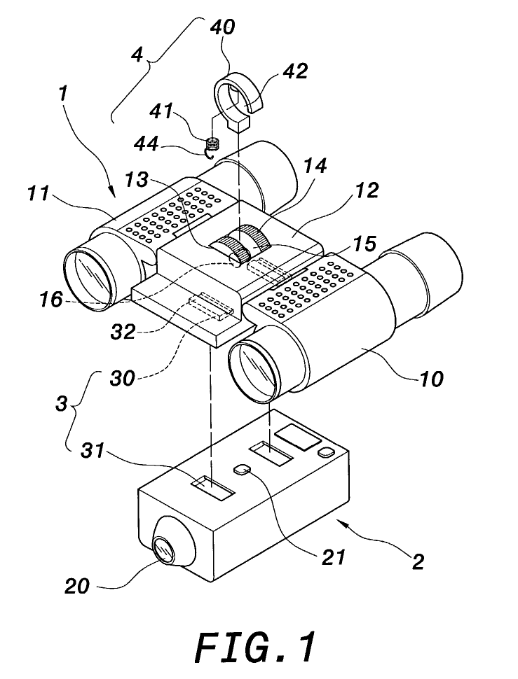

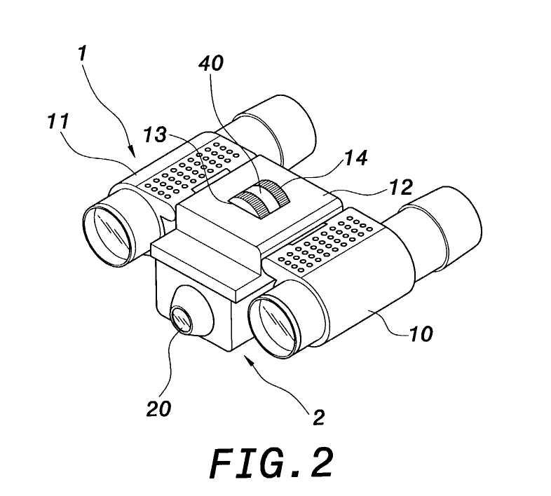

Referring to FIGS. 1, 2, and 3, a detachable telescope camera in accordance with the present invention is shown comprised of a telescope unit 1, a digital camera 2, a detachable coupling structure 3, and a shutter release linking device 4.

The telescope unit 1 in accordance with the present preferred embodiment is a binoculars comprising two telescopes 10;11 (each telescope holds an eyepiece and an objective lens at two distal ends; because the structure of the telescopes is of the known art, no further detailed description is necessary), a frame 12 joining the telescopes 10;11, the frame 12 having a top opening 13 at the center, and a central focusing drive 14 pivotally mounted in top opening 13 of the frame 12 and adapted for adjusting the focal distance of the telescopes 10;11. The digital camera 2 is provided at the bottom side of the telescope unit 1, comprising a lens 20 disposed in the rear side thereof and adapted for focusing the image of the field viewed, and a shutter release 21 for controlling the action of taking the photo of the field viewed.

The detachable coupling structure 3 is adapted for securing the digital camera 2 to the telescope unit 1. When unfastened the detachable coupling structure 3, the digital camera 2 and the telescope unit 1 can be separately used. According to the present preferred embodiment, the detachable coupling structure 3 comprises a hook member 30 fixedly provided at the bottom side of the frame 12 of the telescope unit 1, and a hook hole 31 formed in the top sidewall of the digital camera 2. The hook member 30 has a front hooked portion 32. When connecting the digital camera 2 and the telescope unit 1 together, attach the digital camera 2 to the telescope unit 1, keeping the hook member 30 inserted into the hook hole 31, and then move the telescope unit 1 forwards relative to the digital camera 2 to force the front hooked portion 32 into engagement with the peripheral wall of the hook hole 31. When separating the telescope unit 1 and the digital camera 2, move the telescope unit 1 backwards relative to the digital camera 2 to disengage the front hooked portion 32 of the hook member 30 from the peripheral wall of the hook hole 31.

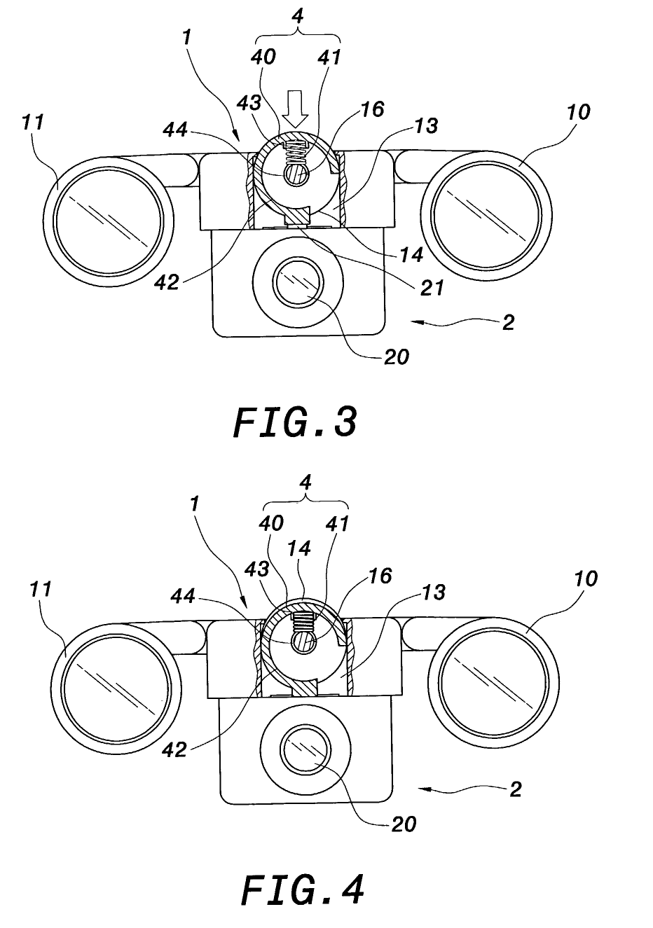

Referring to FIGS. from 1 through 3 again, the central focusing drive 14 comprises a center shaft 16 axially disposed on the middle, and an annular groove 15 around the center shaft 16. The shutter release linking device 4 is comprised of a press member 40 and a spring member 41. The press member 40 is shaped like a split ring mounted in the annular groove 15 around the center shaft 16 of the central focusing drive 14, keeping one end, namely, the downwardly protruded bottom end disposed in contact with the shutter release 21 of the digital camera 2. The split ring-like press member 40 comprises an opening 42, which receives the center shaft 16 of the central focusing drive 14. The spring member 41 is mounted in the opening 42 of the press member 40 and connected between the press member 40 and the center shaft 16 of the central focusing drive 14. Normally, the spring member 41 supports the press member 40 in the upper position where the downwardly protruded bottom end of the press member 40 is disposed in contact with the shutter release 21 of the digital camera 2 and the shutter release 21 of the digital camera 2 is off (see FIG. 3). When pressed the press member 40 with the finger, the press member 40 is lowered from the upper position to the lower position to switch on the shutter release 21 of the digital camera 2 (see FIG. 4).

Referring to FIGS. 3 and 4 again, the press member 40 comprises a downward projection 43 suspended in the opening 42 above the center shaft 16 of the central focusing drive 14. The spring member 41 is a compression spring coupled to the downward projection 43 of the press member 40 and supported on the periphery of the center shaft 16 of the central focusing drive 14, having a bottom endpiece 44 shaped like split ring and fastened to the center shaft 16 of the central focusing drive 14.

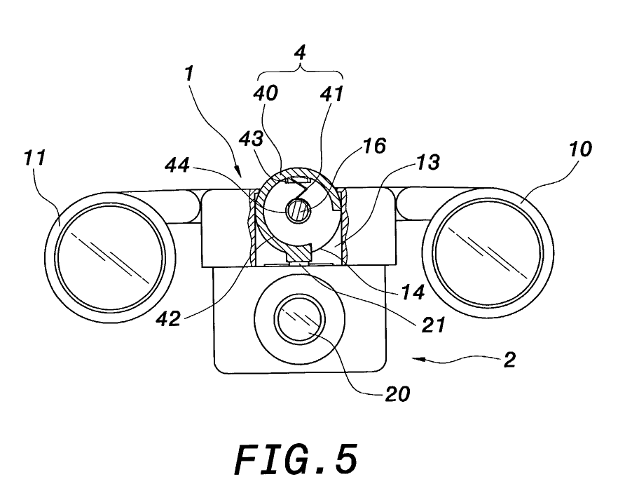

FIG. 5 shows an alternate form of the present invention. According to this alternate form, the spring member 41 is a spring leaf, having a top end fastened to the downward projection 43 of the press member 40 and a bottom endpiece 44 smoothly circularly notched and coupled to the periphery of the center shaft 16 of the central focusing drive 14. The spring member 41 supports the press member 40 in the off position. When the user pressed the press member 40 to compress the spring member 41, the press member 40 is forced to trigger the shutter release 21 of the digital camera 2.

As indicated above, the present invention provides a telescope camera, which enables the user to use the digital camera 2 with the telescope unit 1. By means of the telescope unit 1, the user can see the image of the field clearly at a distance. When viewing the image of the field at a distance, the user-can take photos of the field by the digital camera 2. After adjustment of the focal length through the central focusing drive 14, the user can photograph the object in view with the digital camera 2 by means of pressing the press member 40 with the same finger used to adjust the central focusing drive 14.

A protocol of detachable telescope camera with shutter release linking means has been constructed with the features of the annexed drawings of FIGS. 1˜3. The detachable telescope camera with shutter release linking means functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A detachable telescope camera comprising:
a telescope unit adapted for viewing the field at a distance, said telescope unit comprising a central focusing drive, said central focusing drive comprising an annular groove around the periphery thereof defining a center shaft;
a digital camera, said digital camera having a shutter release adapted for controlling the action of taking the photo of the object viewed;
detachable coupling means adapted for detachably securing said digital camera to said telescope unit at a bottom side and adapted for taking photos of the object viewed through said telescope unit; and
shutter release linking means installed in said telescope unit and adapted for triggering said shutter release of said digital camera, said shutter release linking means comprising a press member suspended in the annular groove of said central focusing drive around said center shaft and adapted for pressing by a finger to trigger said shutter release of said digital camera, said press member having an opening, which receives said center shaft of said central focusing drive, and a downwardly protruded bottom end disposed in contact with said shutter release of said digital camera, and a spring member connected between said press member and said center shaft of said central focusing drive and supporting said press member in an off position where said shutter release of said digital camera is off.

2. The detachable telescope camera as claimed in claim 1, wherein said telescope unit is a binocular.

3. The detachable telescope camera as claimed in claim 1, said telescope unit further comprises two telescopes and a frame joining said telescopes, said frame comprising a top opening, which receives said central focusing drive.

4. The detachable telescope camera as claimed in claim 1, wherein said digital camera comprises a lens disposed in a rear side thereof and adapted for focusing the image of the object viewed.

5. The detachable telescope camera as claimed in claim 1, wherein said detachable coupling structure comprises a hook member fixedly provided at a bottom side of said telescope unit, said hook member having a front hooked portion, and a hook hole formed in a top sidewall of said digital camera and adapted for receiving said hook member.

6. The detachable telescope camera as claimed in claim 1, wherein said spring member is a compression spring.

7. The detachable telescope camera as claimed in claim 6, wherein said compression spring has a top end connected to said press member inside the opening of said press member, and a bottom end terminating in a split ring and fastened to said center shaft of said central focusing drive.

8. The detachable telescope camera as claimed in claim 1, wherein said spring member is a spring leaf.

9. The detachable telescope camera as claimed in claim 8, wherein said spring leaf has a top end fastened to an upper part of said press member in the opening of said press member, and a bottom end smoothly circularly notched and coupled to the periphery of said center shaft of said central focusing drive.

10. The detachable telescope camera as claimed in claim 1, wherein said press member comprises a downward projection suspended in a top side inside the opening thereof and connected to one end of said spring member.
